(19) United States
(12) Patent Application Publication
(10) Pub. No.: US 2019/0284515 A1
(43) Pub. Date: Sep. 19, 2019

(54) SOLID SOAP COMPOSITION

(71) Applicant: COSMETIC WARRIORS LIMITED, Poole, Dorset (GB)

(72) Inventors: Mark CONSTANTINE, Poole, Dorset (GB); Margaret Joan CONSTANTINE, Poole, Dorset (GB); Helen Elizabeth AMBROSEN, Poole, Dorset (GB); Rowena Jacqueline BIRD, Christchurch (GB); Simon CONSTANTINE, Poole, Dorset (GB); Wesley BURRAGE, Poole, Dorset (GB); Daniel CAMPBELL, Poole, Dorset (GB)

(21) Appl. No.: 16/319,277

(22) PCT Filed: Jul. 20, 2017
(86) PCT No.: PCT/GB2017/052136

§ 371 Date: Jan. 18, 2019

(30) Foreign Application Priority Data
Jul. 21, 2016 (GB) 1612658.3

(51) Int. Cl. C11D 17/06; C11D 9/00; C11D 9/26; C11D 13/20; C11D 13/16

(52) U.S. Cl. CPC C11D 17/06; C11D 9/00; C11D 13/16; C11D 13/20; C11D 9/265

(57) ABSTRACT

A solid soap composition includes soap in an amount of at least 70% by weight of the solid soap composition. The solid soap composition (i) has a pH of from 7 to 9.5, and (ii) contains water in an amount of from 0.01 to 15% by weight of the solid soap composition.

### FIELD OF THE INVENTION

The present invention relates to a solid soap composition, a process for producing said solid soap composition, a process for preparing a solid soap product from said solid soap composition, and a product prepared by the process herein.

### BACKGROUND TO THE INVENTION

The present invention relates to products particularly those for use in contact with the human body.

For millennia, soaps have been used for the purposes of washing the skin and clothes. The earliest recorded use of soap as a cleansing agent was in ancient Babylon in approximately 2800BC, where a soap formed from water, cinnamon oil and dissolved ashes was used to wash clothes and prepare wool for weaving. The Egyptians also substantiated the use of soap derivatives for the purposes of personal hygiene, medicinal applications and the effective washing of garments. Indeed, the Egyptians prepared soap recipes using vegetable fats, whilst the Greeks utilised ash, water, cypress oil and sesame oil. However it wasn't until AD77 with the publication of the Roman Scientist Pliny the Elder's Historia Naturalis that the word sapo (Latin for soap) was used. The book discusses the manufacture of sapo from tallow and ashes and its application as a hair pomade. But it was the celebrated Roman physician Galen in AD300 who described the use of soap to wash away impurities from the body.

The appeal of soap as a cleansing and personal hygiene agent grew, although it wasn't until the 15th and 16th centuries, when soap became semi-industrialised and the role it played in personal hygiene was understood, that soap became a universally accepted cleansing product in industrialised nations. In the 16th century there had become a demand for finer soaps and the industry moved away from animal fats towards finer vegetable oils such as olive oil. The use of soap has become universal in industrialised nations due to a better understanding of the role of hygiene in reducing the population size of potentially hazardous microorganisms. Industrially manufactured bar soaps first became available in the late 18th century, as advertising campaigns in Europe and the United States promoted popular awareness of the relationship between cleanliness and health.

The chemistry of soap is relatively simple; soap is an ionic compound that is produced along with glycerol from the neutralisation reaction between the fatty acid of a triglyceride and an alkali. The fatty acid source is typically derived from vegetable oils and butter, the blends of butters or oils used in the soap will determine the properties of the soap. For example, oils with high lauric acid (a saturated fatty acid) content such as coconut oil or palm oil will produce a greater amount of soap suds compared to olive oil or cocoa butter which contain only trace levels.

The alkali used in soap manufacture is typically sodium hydroxide (or for liquid soaps potassium hydroxide). The sodium hydroxide is diluted to a 30-50% solution with distilled or deionised water. Distilled/deionised water is used as excessive amounts of heavy metals that may be in the water can disrupt the saponification reaction. The production of this solution is an exothermic reaction. The sodium hydroxide solution is then gently stirred and cooled to between 30° C.-50° C. Once the two phases are at comparable temperatures, the sodium hydroxide solution is mixed with the fatty acids. The majority of the saponification reaction is completed within 5-10 minutes. However, it can take up to 2 months to cure the soap in order for the soap to reach a pH where it is acceptable to be used for cosmetic purposes. As the skilled person will appreciate, soap is typically cured in order to ensure that the saponification process is entirely complete, and in order to allow for sufficient water to evaporate from the soap to harden the soap. Therefore, during the curing step in the production of soap, the pH of the soap is typically reduced as the saponification reaction reaches completion.

Whilst soap is an effective cleansing agent, it is widely acknowledged that soap can cause dryness and irritation, such as erythema, scaling and fissure formation, to delicate and sensitive skin. This is due to the alkalinity of soap and its cleansing action adversely affecting the cutaneous bacterial flora, enzyme activity in the upper epidermis (stratum corneum) and naturally occurring oils found on the skin and hair.

The present invention seeks to provide a solid soap composition that is suitable for use on delicate and sensitive skin types, and a method for producing a solid soap composition with a rapid curing phase.

### SUMMARY OF THE INVENTION

In a first aspect, there is provided a solid soap composition comprising soap in an amount of at least 70% by weight of the solid soap composition, wherein the solid soap composition

(i) has a pH of from 7 to 9.5,

(ii) contains water in an amount of from 0.01 to 15% by weight of the solid soap composition.

In a second aspect, there is provided a process for the production of a soap composition comprising the steps of

(a) contacting a hydroxide solution and a triglyceride to form a saponification mixture;

(b) agitating the saponification mixture at a temperature of from 50 to 70° C. until the mixture has a viscosity of from 300 to 500 cP;

(c) curing the mixture of step (b) at a temperature of from 130 to 170° C. to form the soap composition.

In a third aspect, there is provided a process for the production of a solid soap product suitable for cleansing the human body, the process comprising the steps of

(a) providing a solid soap base comprising soap and glycerol;

(b) heating the solid soap base to provide the soap base in liquid form, and optionally contacting the soap base with glycerol, to form a soap liquid mixture;

(c) pouring the soap liquid mixture into a mould and allowing to set to form the solid soap product,

wherein the solid soap product contains glycerol in an amount of from 0.01 to 35% by weight of the solid soap product; and
wherein no greater than 80% by weight of the glycerol present in the solid soap product is added to the soap base.

In a fourth aspect, there is provided a solid soap product suitable for cleansing the human body obtained or obtainable from a process, the process comprising the steps of

(a) providing a solid soap base comprising soap and glycerol;

(b) heating the solid soap base to provide the soap base in liquid form, and optionally contacting the soap base with glycerol, to form a soap liquid mixture;

(c) pouring the soap liquid mixture into a mould and allowing to set to form the solid soap product

wherein the solid soap product contains glycerol in an amount of from 0.01 to 35% by weight of the solid soap product; and
wherein no greater than 80% by weight of the glycerol present in the solid soap product is added to the soap base.

The skin comprises a complex and dynamical physiological equilibrium that forms a protective barrier between the human body and its external environment. Key physiochemical features, such as hydration levels, temperature and pH are maintained and adjusted in response to external factors affecting the skin's physiological equilibrium.

The natural pH of skin plays an important role in its overall physiology, directly or indirectly influencing various factors, such as stratum corneum lipids, stratum corneum hydration levels, the skin's barrier function and cutaneous bacterial flora. The skin's natural pH is generally recognised to range between 5.4-5.9 due to an acidic protective barrier referred to as the acid mantle. The acid mantle is a hydrolipid layer comprising secretions from the sebaceous and eccrine sweat glands, such as lactic acid, urocanic acid and fatty acid derivatives that ultimately yield sebum.

It is known that cleansing of the skin using conventional soap results in a transient increase in the skin's pH, affecting the skin's physiological equilibrium and potentially causing skin irritation. By using a conventional soap, whereby the pH typically ranges from 10-11, the pH of the skin can be increased by 3 units for several hours, thereby adversely affecting the skin's protective barrier functions.

The present inventors have found that by using soap compositions that have a pH of from 7 to 9.5, a materially gentler cleansing action may be achieved, when compared to a conventional soap composition, which does not result in irritation or dryness of delicate or sensitive skin types.

For ease of reference, these and further aspects of the present invention are now discussed under appropriate section headings. However, the teachings under each section are not necessarily limited to each particular section.

### DETAILED DESCRIPTION

Solid Soap Composition

As discussed herein, in one aspect of the present invention, there is provided a solid soap composition comprising soap in an amount of at least 70% by weight of the solid soap composition, wherein the solid soap composition

(i) has a pH of from 7 to 9.5,

(ii) contains water in an amount of from 0.01 to 15% by weight of the solid soap composition.

As discussed herein, the soap composition is a solid soap composition. Solid products of the present invention are compositions which can substantially sustain their physical shape when unsupported by external means, e.g. packaging etc. Thus, they are considered to be solid, solid like, in solid form or in solid-like form at room temperature.

For the avoidance of doubt the solid product must remain substantially solid at up to 30° C.

By solid-like, it is understood that some materials are considered on a day to day basis to be solid, yet over an extremely long period of time, may alter in shape, e.g. amorphous materials such as glass etc. However, they are considered to be solid-like as, for the purpose they fulfil, they are solid. The solid form of the solid compositions of the present invention means that external packaging is not required to maintain the shape of the composition.

Soap

As will be understood by one skilled in the art, soap is a salt of fatty acid produced by the saponification of triglycerides using a strong alkali solution. Typically the soap of the present invention will be a sodium salt of one or more fatty acids.

According to the present invention, the soap is present in an amount of at least 70% by weight of the solid soap composition.

In one preferred aspect, the soap is present in an amount of at least 75% by weight of the solid soap composition, such as in an amount of at least 80% by weight of the solid soap composition, such as in an amount of at least 82.5% by weight of the solid soap composition, such as in an amount of at least 85% by weight of the solid soap composition.

In some embodiments, the soap is present in an amount of from 70 to 100% by weight of the solid soap composition, such as from 75 to 95% by weight of the solid soap composition, such as in an amount of from 80 to 90% by weight of the solid soap composition, such as in an amount of approximately 85% by weight of the solid soap composition.

In one preferred aspect, the solid soap composition consists essentially of soap, water and glycerol. As used herein, “consists essentially of” means that other non-specified components may also be present in the composition, provided that the essential characteristics of the composition are not materially affected by their presence. In some embodiments, the solid soap composition consists of soap, water and glycerol.

The soap present in the soap compositions described herein may be from any suitable source. In one aspect the soap is saponified vegetable oil, saponified vegetable butter, or a mixture thereof. In one aspect the soap is saponified vegetable oil. In one aspect the soap is saponified vegetable butter.

In some embodiments, the soap comprises salts of fatty acids that comprise a mixture of saturated and unsaturated fatty acids. As used herein, the term “saturated fatty acid” means a triglyceride compound in which each fatty acid chain is saturated such that each fatty acid chain consists of single carbon-carbon bonds. As used herein, the term “unsaturated fatty acid” means a triglyceride compound in which at least one of the fatty acid chains is unsaturated such that at least one fatty acid chain comprises at least one carbon-carbon double or triple bond.

In some embodiments, the solid soap composition comprises saturated fatty acid salts in an amount of from 1 to 80% by weight of the solid soap composition. In some aspects, the solid soap composition comprises saturated fatty acid salts in an amount of from 1 to 75% by weight of the solid soap composition, such as from 1 to 72.5% by weight of the solid soap composition, such as from 1.25 to 70% by weight of the solid soap composition, such as from 1.25 to 67.5% by weight of the solid soap composition.

In some embodiments, the solid soap composition comprises saturated fatty acid salts in an amount of from 1 to 80% by weight of the total amount of soap in the solid soap composition, such as from 1.5 to 75% by weight of the total amount of soap in the solid soap composition.

In some embodiments, the solid soap composition comprises unsaturated fatty acid salts in an amount of greater than 15% by weight of the solid soap composition. In some aspects, the solid soap composition comprises unsaturated fatty acid salts in an amount of from 15 to 99% by weight of the solid soap composition, such as from 17.5 to 98.5% by weight of the solid soap composition, such as from 20 to 98% by weight of the solid soap composition, such as from 20 to 95% by weight of the solid soap composition, such as from 20 to 90% by weight of the solid soap composition. In one preferred aspect, the solid soap composition comprises unsaturated fatty acid salts in an amount of from 15 to 95% by weight of the solid soap composition.

In some embodiments, the solid soap composition comprises unsaturated fatty acid salts in an amount of from 20 to 100% by weight of the total amount of soap in the solid soap composition, such as from 22.5 to 98% by weight of the total amount of soap in the solid soap composition.

In some embodiments, the soap is derived from fatty acids having a carbon chain length of 8 carbon atoms (C8) in an amount of from 0 to 10% by weight of the total amount of fatty acids in the solid soap composition such as in an amount of from 0 to 5% by weight of the total amount of fatty acids in the solid soap composition, such as in an amount of from 0 to 4% by weight of the total amount of fatty acids in the solid soap composition.

In some embodiments, the soap is derived from fatty acids having a carbon chain length of 10 carbon atoms (010) in an amount of from 0 to 10% by weight of the total amount of fatty acids in the solid soap composition, such as in an amount of from 0 to 5% by weight of the total amount of fatty acids in the solid soap composition, such as in an amount of from 0 to 4% by weight of the total amount of fatty acids in the solid soap composition, such as in an amount of from 0 to 3% by weight of the total amount of fatty acids in the solid soap composition.

In some embodiments, the soap is derived from fatty acids having a carbon chain length of 12 carbon atoms (C12) in an amount of from 0 to 25% by weight of the total amount of fatty acids in the solid soap composition, such as in an amount of from 0 to 24% by weight of the total amount of fatty acids in the solid soap composition, such as in an amount of from 0 to 23% by weight of the total amount of fatty acids in the solid soap composition, such as in an amount of from 0 to 22% by weight of the total amount of fatty acids in the solid soap composition, such as in an amount of from 0 to 21.5% by weight of the total amount of fatty acids in the solid soap composition.

In some embodiments, the soap is derived from fatty acids having a carbon chain length of 14 carbon atoms (C14) in an amount of from 0 to 10% by weight of the total amount of fatty acids in the solid soap composition, such as in an amount of from 0 to 9% by weight of the total amount of fatty acids in the solid soap composition, such as in an amount of from 0 to 8% by weight of the total amount of fatty acids in the solid soap composition, such as in an amount of from 0.01 to 8% by weight of the total amount of fatty acids in the solid soap composition, such as in an amount of from 0.05 to 8% by weight of the total amount of fatty acids in the solid soap composition.

In some embodiments, the soap is derived from fatty acids having a carbon chain length of 16 carbon atoms (C16) in an amount of from 0 to 30% by weight of the total amount of fatty acids in the solid soap composition, such as in an amount of from 1 to 25% by weight of the total amount of fatty acids in the solid soap composition, such as in an amount of from 2 to 25% by weight of the total amount of fatty acids in the solid soap composition, such as in an amount of from 3 to 25% by weight of the total amount of fatty acids in the solid soap composition, such as in an amount of from 4 to 25% by weight of the total amount of fatty acids in the solid soap composition, such as in an amount of from 5 to 25% by weight of the total amount of fatty acids in the solid soap composition, such as in an amount of from 6 to 25% by weight of the total amount of fatty acids in the solid soap composition, such as from 7 to 25% by weight of the total amount of fatty acids in the solid soap composition, such as from 8 to 25% by weight of the total amount of fatty acids in the solid soap composition, such as from 9 to 25% by weight of the total amount of fatty acids in the solid soap composition.

In some embodiments, the soap is derived from fatty acids having a carbon chain length of 18 carbon atoms (C18) in an amount of from 1 to 99% by weight of the total amount of fatty acids in the solid soap composition, such as in an amount of from 5 to 95% by weight of the total amount of fatty acids in the solid soap composition, such as in an amount of from 10 to 90% by weight of the total amount of fatty acids in the solid soap composition, such as in an amount of from 15 to 90% by weight of the total amount of fatty acids in the solid soap composition, such as in an amount of from 20 to 90% by weight of the total amount of fatty acids in the solid soap composition, such as in an amount of from 25 to 90% by weight of the total amount of fatty acids in the solid soap composition, such as in an amount of from 30 to 90% by weight of the total amount of fatty acids in the solid soap composition, such as from 35 to 90% by weight of the total amount of fatty acids in the solid soap composition, such as from 40 to 90% by weight of the total amount of fatty acids in the solid soap composition, such as from 41 to 88% by weight of the total amount of fatty acids in the solid soap composition.

In some embodiments, the soap is derived from fatty acids having a carbon chain length of 20 carbon atoms (C20) in an amount of from 0 to 10% by weight of the total amount of fatty acids in the solid soap composition, such as in an amount of from 0.1 to 10% by weight of the total amount of fatty acids in the solid soap composition, such as in an amount of from 0.2 to 9% by weight of the total amount of fatty acids in the solid soap composition, such as in an amount of from 0.3 to 8% by weight of the total amount of fatty acids in the solid soap composition, such as in an amount of from 0.4 to 7% by weight of the total amount of fatty acids in the solid soap composition, such as in an amount of from 0.5 to 6% by weight of the total amount of fatty acids in the solid soap composition, such as in an amount of from 0.5 to 6% by weight of the total amount of fatty acids in the solid soap composition.

In some embodiments, the soap is derived from fatty acids having a carbon chain length of 22 carbon atoms (C22) in an amount of from 0 to 10% by weight of the total amount of fatty acids in the solid soap composition, such as in an amount of from 0 to 5% by weight of the total amount of fatty acids in the solid soap composition, such as in an amount of from 0 to 4% by weight of the total amount of fatty acids in the solid soap composition, such as in an amount of from 0 to 3% by weight of the total amount of fatty acids in the solid soap composition, such as in an amount of from 0 to 2% by weight of the total amount of fatty acids in the solid soap composition, such as in an amount of from 0 to 1% by weight of the total amount of fatty acids in the solid soap composition, such as in an amount of from 0.1 to 1% by weight of the total amount of fatty acids in the solid soap composition.

In some embodiments, the soap is derived from fatty acids having a carbon chain length of 24 carbon atoms (C24) in an amount of from 0 to 10% by weight of the total amount of fatty acids in the solid soap composition, such as in an amount of from 0 to 5% by weight of the total amount of fatty acids in the solid soap composition, such as in an amount of from 0 to 4% by weight of the total amount of fatty acids in the solid soap composition, such as in an amount of from 0 to 3% by weight of the total amount of fatty acids in the solid soap composition, such as in an amount of from 0 to 2% by weight of the total amount of fatty acids in the solid soap composition, such as in an amount of from 0.01 to 2% by weight of the total amount of fatty acids in the solid soap composition, such as in an amount of from 0.05 to 1.5% by weight of the total amount of fatty acids in the solid soap composition.

In some embodiments, the soap is derived from a vegetable butter and/or vegetable oil. In some embodiments the vegetable butter is selected from the group comprising cocoa butter, illipe butter, murumuru butter, kokum butter, aloe butter, avocado butter, cupuacu butter, macadamia nut butter, mango butter, olive butter, shea butter, coconut butter, pumpkin seed butter, peanut butter, almond butter, coffee bean butter, refined butter, hemp seed butter, mochacchino butter, pistachio nut butter, shealoe butter and mixtures thereof. In some embodiments, the vegetable oil is selected from the group comprising sunflower oil, almond oil, seasame oil, rosehip oil, almond oil, raspberry seed oil, jojoba oil, avocado oil, castor oil, coconut oil, rapeseed oil, moringa oil, olive oil, grapeseed oil, argan oil, baobab oil, kalahari melon oil, brazil nut oil and mixtures thereof.

In some embodiments, the soap is derived from a vegetable butter and/or vegetable oil selected from the group comprising cocoa butter, shea butter, avocado oil, argan oil, sunflower oil, Kalahari melon oil, baobab oil, castor oil, coconut oil, rapeseed oil, almond oil, olive oil and mixtures thereof.

In one preferred aspect, the solid soap composition comprises soap in an amount of at least 70% by weight of the solid soap composition, wherein the solid soap composition

(i) has a pH of from 7 to 9.5,

(ii) contains water in an amount of from 0.01 to 15% by weight of the solid soap composition,

wherein the soap comprises saturated fatty acids in an amount of from 1 to 80% by weight of the solid soap composition, and wherein the soap comprises unsaturated fatty acids in an amount of from 15 to 95% by weight of the solid soap composition.

As described herein, in one aspect of the present invention, the solid soap composition has a pH of from 7 to 9.5.

In one preferred aspect of the present invention, the solid soap composition has a pH of from 7 to 9.5, such as from 7 to 9.4, such as from 7 to 9.3, such as from 7 to 9.2, such as from 7 to 9.1, such as from 7 to 9, such as from 7 to 8.9. In one preferred aspect of the present invention, the solid soap composition has a pH of from 7.1 to 9.5, such as from 7.2 to 9.5, such as from 7.3 to 9.5, such as from 7.4 to 9.5, such as from 7.5 to 9.5, such as from 7.6 to 9.5, such as from 7.7 to 9.5, such as from 7.8 to 9.5, such as from 7.9 to 9.5. In one preferred aspect of the present invention, the solid soap composition has a pH of from 7.1 to 9.5, such as from 7.1 to 9.3, such as from 7.5 to 9.5, such as from 7.5 to 9.3, such as from 7.9 to 9.5, such as from 7.9 to 9.3, such as from 8 to 9.5, such as from 8.1 to 9.5, such as from 8.2 to 9.5.

It has been found that providing a solid soap composition having a pH within the ranges provided above results in a materially gentler cleansing action compared to a conventional soap composition, which does not result in irritation or dryness of delicate or sensitive skin types.

Water

As described herein, water is present in an amount of from 0.01 to 15% by weight of the solid soap composition.

In one preferred aspect water is present in an amount of from 0.01 to 14% by weight of the solid soap composition. In one preferred aspect water is present in an amount of from 0.01 to 12.5% by weight of the solid soap composition. In one preferred aspect water is present in an amount of from 0.01 to 10% by weight of the solid soap composition. In one preferred aspect water is present in an amount of from 0.05 to 10% by weight of the solid soap composition. In one preferred aspect water is present in an amount of from 0.1 to 10% by weight of the solid soap composition. In one preferred aspect water is present in an amount of from 0.15 to 10% by weight of the solid soap composition. In one preferred aspect water is present in an amount of from 0.2 to 10% by weight of the solid soap composition. In one preferred aspect water is present in an amount of from 0.2 to 9% by weight of the solid soap composition. In one preferred aspect water is present in an amount of from 0.2 to 8% by weight of the solid soap composition. In one preferred aspect water is present in an amount of from 0.2 to 7.5% by weight of the solid soap composition. In one preferred aspect water is present in an amount of from 0.2 to 7% by weight of the solid soap composition.

Glycerol

In one preferred aspect, the solid soap composition further comprises glycerol. As the skilled person appreciates, glycerol is a well-known by-product of saponification and is present in all soap compositions to varying degrees. In the majority of commercially available solid soap compositions, glycerol is removed and utilised as a separate commodity due to its wide range of potential applications, such as in the food, pharmaceutical and cosmetics industries.

Glycerol is also widely known for its use as a humectant in cosmetic and personal care products, as it is capable of absorbing moisture from the air, maintaining a higher moisturised and hydrated upper epidermis, and improving the skin's barrier function. Soap compositions with a high glycerol content are often used for delicate and sensitive skin types, as they are generally considered to reduce the drying effect caused by conventional soaps. However, soap compositions containing high levels of glycerol are prone to cracking and increased levels of mush due to the ability of glycerol to absorb moisture from the air and environment, which penetrates the solid soap compositions. As used herein, “mush” is a paste that is formed when soap compositions are left in contact with water for prolonged periods of time. “Mush” is defined herein as a paste in which soluble components of the soap dissolve out of the composition and water is absorbed into the remaining solid soap, causing swelling and softening of the composition. Cracking occurs as a result of the contraction and reduced plasticity of the soap composition as it dries.

In one preferred aspect the solid soap composition comprises glycerol in an amount of from 0.01 to 15% by weight of the solid soap composition, such as in an amount of from 0.01 to 12.5% by weight of the solid soap composition, such as in an amount of from 0.01 to 10% by weight of the solid soap composition. In one preferred aspect the solid soap composition comprises glycerol in an amount of from 0.05 to 15% by weight of the solid soap composition, such as in an amount of from 0.1 to 15% by weight of the solid soap composition, such as in an amount of from 0.5 to 15% by weight of the solid soap composition, such as in an amount of from 1 to 15% by weight of the solid soap composition, such as in an amount of from 2.5 to 15% by weight of the solid soap composition, such as in an amount of from 5 to 15% by weight of the solid soap composition, such as in an amount of from 5.5 to 15% by weight of the solid soap composition.

In one preferred aspect of the present invention, the solid soap composition comprises glycerol in an amount of from 0.01 to 15% by weight of the solid soap composition. In one preferred aspect the solid soap composition comprises glycerol in an amount of from 1 to 10% by weight of the solid soap composition. In one preferred aspect the solid soap composition comprises glycerol in an amount of from 5 to 10% by weight of the solid soap composition.

It was surprisingly found that, when the solid soap composition of the present invention is used as a soap base in the manufacture of a solid soap product suitable for cleansing the human body, providing a solid soap composition comprising glycerol in an amount of 0.01 to 15% by weight of the solid soap composition, it is possible to reduce or avoid the necessity to add supplementary glycerol during a later stage of the manufacturing process. The presence of glycerol in an amount of from 0.01 to 15% by weight of the solid soap composition may also enable the solid soap composition to dissolve much more efficiently in the syrup produced during the process of manufacturing a solid soap product (e.g. in the ‘melt and pour’ process described herein). This may lead to a reduction in the time required to completely dissolve the soap composition during the manufacturing process.

In one preferred aspect, the solid soap composition comprises soap in an amount of at least 70% by weight of the solid soap composition, wherein the solid soap composition

(i) has a pH of from 7 to 9.5,

(ii) contains water in an amount of from 0.01 to 15% by weight of the solid soap composition,

(iii) contains glycerol in an amount of from 0.01 to 15% by weight of the solid soap composition.

Particle Size

In one preferred aspect of the present invention, the solid soap composition is in particulate form. In one preferred aspect, the solid soap composition is in particulate form, wherein at least 90% by weight of the solid soap composition has a size of greater than 1 mm.

In some embodiments, the solid soap composition is in particulate form, wherein at least 95% by weight of the solid soap composition has a size of greater than 1 mm, such as at least 96% by weight of the solid soap composition has a size of greater than 1 mm, such as at least 97% by weight of the solid soap composition has a size of greater than 1 mm, such as at least 98% by weight of the solid soap composition has a size of greater than 1 mm.

In some embodiments, the solid soap composition is in particulate form, wherein at least 90% by weight of the solid soap composition has a size of from 1 to 80 mm, such as at least 95% by weight of the solid soap composition has a size of from 1 to 80 mm, such as at least 96% by weight of the solid soap composition has a size of from 1 to 80 mm, such as at least 97% by weight of the solid soap composition has a size of from 1 to 80 mm, such as at least 98% by weight of the solid soap composition has a size of from 1 to 80 mm.

In some embodiments, the solid soap composition is in particulate form, wherein at least 90% by weight of the solid soap composition has a size of from 1 to 75 mm, such as at least 90% by weight of the solid soap composition has a size of from 1 to 70 mm, such as at least 95% by weight of the solid soap composition has a size of from 1 to 70 mm, such as at least 98% by weight of the solid soap composition has a size of from 1 to 70 mm.

In some embodiments, the solid soap composition is in particulate form, wherein at least 45% by weight of the solid soap composition has a size of less than 5 mm, such as at least 50% by weight of the solid soap composition has a size of less than 5 mm, such as at least 55% by weight of the solid soap composition has a size of less than 5 mm, such as at least 60% by weight of the solid soap composition has a size of less than 5 mm, such as at least 65% by weight of the solid soap composition has a size of less than 5 mm, such as at least 70% by weight of the solid soap composition has a size of less than 5 mm.

In some embodiments, the solid soap composition is in particulate form, wherein at least 45% by weight of the solid soap composition has a particle size of from 1 to 5 mm, such as at least 50% by weight of the solid soap composition has a particle size of from 1 to 5 mm, such as at least 55% by weight of the solid soap composition has a particle size of from 1 to 5 mm, such as at least 60% by weight of the solid soap composition has a particle size of from 1 to 5 mm, such as at least 65% by weight of the solid soap composition has a particle size of from 1 to 5 mm.

It was surprisingly found that, when at least 90% by weight of the solid composition has a size of from 1 to 80 mm, there may be improvements in the process for producing a solid soap product suitable for cleansing the human body from the solid soap composition. In particular, it was surprisingly found that dissolution of the soap composition during the ‘melt and pour’ manufacturing process of a solid soap product suitable for cleansing the human body may be improved. It was found that, if the particulates of the solid soap composition have a size of greater than 80 mm, a mass agglomerate may be formed, which may subsequently deteriorate due to excessive heat transfer and ineffectual dissolution within the aqueous phase. If the particle size is less than 1 mm, the particulates of the solid soap composition may remain on the surface of the aqueous phase and form a layer, which may subsequently deteriorate due to excessive heat transfer and ineffectual dissolution within the aqueous phase.

In one preferred aspect, the solid soap composition comprises soap in an amount of at least 70% by weight of the solid soap composition, wherein the solid soap composition

(i) has a pH of from 7 to 9.5,

(ii) contains water in an amount of from 0.01 to 15% by weight of the solid soap composition, and

(iii) is in particulate form, wherein at least 90% by weight of the solid soap composition has a size of from 1 to 80 mm.

Density

In one preferred aspect of the present invention, the solid soap composition has a density of from 0.5 g/cm³ to 1.5 g/cm³.

In one preferred aspect of the present invention, the solid soap composition has a density of from 0.5 to 1.5 g/cm³, such as from 0.6 to 1.25 g/cm³, such as from 0.7 to 1.1 g/cm³, such as from 0.75 to 1.1 g/cm³, such as from 0.8 to 1.1 g/cm³, such as from 0.85 to 1.1 g/cm³, such as from 0.9 to 1.1 g/cm³.

It was surprisingly found that, when the solid soap composition has a density of from 0.5 to 1.5 g/cm³, there may be improvements in the process for producing a solid soap product suitable for cleansing the human body from the solid soap composition. In particular, it was surprisingly found that dissolution of the soap composition during the ‘melt and pour’ manufacturing process of a solid soap product suitable for cleansing the human body may be improved. It was found that, if the particulates of the solid soap composition have a density of greater than 1.5 g/cm³, a mass agglomerate may be formed, which may subsequently deteriorate due to excessive heat transfer and ineffectual dissolution within the aqueous phase. If the density is less than 0.5 glcm³, the particulates of the solid soap composition may remain on the surface of the aqueous phase and form a layer, which may subsequently deteriorate due to excessive heat transfer and ineffectual dissolution within the aqueous phase.

In one preferred aspect, the solid soap composition comprises soap in an amount of at least 70% by weight of the solid soap composition, wherein the solid soap composition

(i) has a pH of from 7 to 9.5,

(ii) contains water in an amount of from 0.01 to 15% by weight of the solid soap composition, and

(iii) has a density of from 0.5 g/cm³ to 1.5 g/cm³.

Composition

In accordance with the present invention, the solid soap composition comprises soap in an amount of at least 70% by weight of the solid soap composition, wherein the solid soap composition

(i) has a pH of from 7 to 9.5, and

(ii) contains water in an amount of from 0.01 to 15% by weight of the solid soap composition.

In one preferred aspect, the solid soap composition comprises soap in an amount of at least 70% by weight of the solid soap composition, wherein the solid soap composition

(i) has a pH of from 7 to 9.5,

(ii) contains water in an amount of from 0.01 to 15% by weight of the solid soap composition,

(iii) contains glycerol in an amount of from 0.01 to 15% by weight of the solid soap composition, and

(iv) is in particulate form, wherein at least 90% by weight of the solid soap composition has a size of from 1 to 80 mm.

In one preferred aspect, the solid soap composition comprises soap in an amount of at least 70% by weight of the solid soap composition, wherein the solid soap composition

(i) has a pH of from 7 to 9.5,

(ii) contains water in an amount of from 0.01 to 15% by weight of the solid soap composition,

(iii) contains glycerol in an amount of from 0.01 to 15% by weight of the solid soap composition,

(iv) is in particulate form, wherein at least 90% by weight of the solid soap composition has a size of from 1 to 80 mm, and

(v) has a density of from 0.5 to 1.5 g/cm³.

In one preferred aspect, the solid soap composition comprises soap in an amount of at least 70% by weight of the solid soap composition, wherein the solid soap composition

(i) has a pH of from 7 to 9.5,

(ii) contains water in an amount of from 0.01 to 15% by weight of the solid soap composition,

(iii) contains glycerol in an amount of from 0.01 to 15% by weight of the solid soap composition,

(iv) is in particulate form, wherein at least 90% by weight of the solid soap composition has a size of from 1 to 80 mm, and

wherein the soap comprises saturated fatty acids in an amount of from 1 to 80% by weight of the solid soap composition, and wherein the soap comprises unsaturated fatty acids in an amount of from 15 to 95% by weight of the solid soap composition.

The solid soap composition may further comprise one or more additional components such as to provide the desired composition. In one aspect the solid soap composition further comprises at least one additional component selected from fragrances, herbs, colourants, chelating agents, cereals, fruits, vegetables, seaweeds, flowers, clays and mixtures thereof. In one aspect, the solid soap composition further comprises at least one additional component selected from fragrances, herbs, colourants, chelating agents cereals, fruits, vegetables, seaweeds, flowers, clays and mixtures thereof in an amount of from 0.1 to 30% by weight of the solid soap composition. In one aspect, the solid soap composition further comprises at least one additional component selected from fragrances, herbs, colourants, cereals, fruits, vegetables, seaweeds, flowers, clays and mixtures thereof in an amount of from 0.1 to 10% by weight of the solid soap composition.

In one aspect, the solid soap composition further comprises a chelating agent. In one preferred aspect, the chelating agent is selected from citric acid, sodium citrate, ethylene diamine tetra acetic acid (EDTA), and mixtures thereof. Preferably, the chelating agent is sodium citrate. In one aspect, the solid soap composition comprises a chelating agent (preferably sodium citrate) in an amount of from 0.1 to 30% by weight of the solid soap composition, such as in an amount of from 10 to 30% by weight of the solid soap composition, such as in an amount of from 20 to 30% by weight of the solid soap composition, such as in an amount of from 22.5 to 27.5% by weight of the solid soap composition, such as in an amount of approximately 25% by weight of the solid soap composition.

The present invention relates to a soap composition or soap base that may be formed into a solid soap product, typically by the melt and pour process described herein. In some embodiments, the melt and pour process described herein does not require the presence of propylene glycol to assist heat transfer when melting the soap, as described in WO 2015/128649. Therefore, the present soap composition or soap base may provide the user with a choice to purchase a soap which does not contain propylene glycol and which has not utilised propylene glycol in its production.

The avoidance of propylene glycol is advantageous for a number of reasons. In particular, propylene glycol is typically derived from the petroleum industry. Many consumers wish to avoid products which rely on fossil fuels as their source materials. Furthermore we have found that the use of propylene glycol in cosmetics may result in skin sensitisation in the user. The present system provides a soap product that may be formed by the melt and pour process, but avoids the disadvantages of prior art systems, namely skin sensitisation when used.

Process

In one aspect of the present invention, there is provided a process for the production of a solid soap composition, the process comprising the steps of:

(a) contacting a hydroxide solution and a triglyceride to form a saponification mixture;

(b) agitating the saponification mixture at a temperature of from 50 to 70° C. until the mixture has a viscosity of from 300 to 500 cP; and

(c) curing the mixture of step (b) at a temperature of from 130 to 170° C. to form the solid soap composition.

In some embodiments, the triglyceride is derived from fatty acids as described hereinabove.

In some embodiments, the triglyceride is derived from a vegetable butter and/or vegetable oil. In some embodiments the vegetable butter is selected from the group comprising cocoa butter, illipe butter, murumuru butter, kokum butter, aloe butter, avocado butter, cupuacu butter, macadamia nut butter, mango butter, olive butter, shea butter, coconut butter, pumpkin seed butter, peanut butter, almond butter, coffee bean butter, refined butter, hemp seed butter, mochacchino butter, pistachio nut butter, shealoe butter and mixtures thereof. In some embodiments, the vegetable oil is selected from the group comprising sunflower oil, almond oil, seasame oil, rosehip oil, almond oil, raspberry seed oil, jojoba oil, avocado oil, castor oil, coconut oil, rapeseed oil, moringa oil, olive oil, grapeseed oil, argan oil, baobab oil, kalahari melon oil, brazil nut oil and mixtures thereof.

In some embodiments, the triglyceride is derived from a vegetable butter and/or vegetable oil selected from the group comprising cocoa butter, shea butter, avocado oil, argan oil, sunflower oil, Kalahari melon oil, baobab oil, castor oil, coconut oil, rapeseed oil, almond oil, olive oil and mixtures thereof.

In some embodiments, the saponification mixture is agitated in step (b) at a temperature of from 55 to 70° C. until the mixture has a viscosity of from 300 to 500 cP. In some embodiments, the saponification mixture is agitated in step (b) at a temperature of from 50 to 65° C. until the mixture has a viscosity of from 300 to 500 cP. In some embodiments, the saponification mixture is agitated in step (b) at a temperature of from 55 to 65° C. until the mixture has a viscosity of from 300 to 500 cP. In some embodiments, the saponification mixture is agitated in step (b) at a temperature of approximately 60° C. until the mixture has a viscosity of from 300 to 500 cP. In some embodiments, the viscosity is as measured by a Viscolite 700 Portable viscometer.

In some embodiments, the viscosity is as measured by a Viscolite 700 Portable viscometer. Thus in a further aspect, the present invention provides a process for the production of a solid soap composition, the process comprising the steps of

(a) contacting a hydroxide solution and a triglyceride to form a saponification mixture;

(b) agitating the saponification mixture at a temperature of from 50 to 70° C. until the mixture has a viscosity of from 300 to 500 cP as measured with a Viscolite 700 Portable viscometer;

(c) curing the mixture of step (b) at a temperature of from 130 to 170° C. to form the solid soap composition.

In some embodiments, the saponification mixture is agitated in step (b) at a temperature of from 50 to 70° C. until the mixture has a viscosity of from 300 to 500 cP, such as a viscosity of from 305 to 495 cP, such as a viscosity of from 310 to 490 cP, such as a viscosity of from 315 to 485 cP, such as a viscosity of from 320 to 480 cP, such as a viscosity of from 320 to 475 cP. In some embodiments, the viscosity is as measured by a Viscolite 700 Portable viscometer. As the skilled person will appreciate, 1 cP (centipoise) is equivalent to 1 mPa·s (millipascal-second). Therefore, in one aspect, the saponification mixture is agitated in step (b) at a temperature of from 50 to 70° C. until the mixture has a viscosity of from 300 to 500 mPa·s.

In some embodiments, the mixture of step (b) is cured in step (c) at a temperature of from 135 to 170° C. to form the solid soap composition. In some embodiments, the mixture of step (b) is cured in step (c) at a temperature of from 135 to 165° C. to form the solid soap composition. In some embodiments, the mixture of step (b) is cured in step (c) at a temperature of from 140 to 160° C. to form the solid soap composition. In some embodiments, the mixture of step (b) is cured in step (c) at a temperature of from 145 to 155° C. to form the solid soap composition. In some embodiments, the mixture of step (b) is cured in step (c) at a temperature of approximately 150° C. to form the solid soap composition.

In some embodiments, the mixture of step (b) is cured in step (c) for a period of no greater than about 24 hours to form the solid soap composition. In some embodiments, the mixture of step (b) is cured in step (c) for a period of no greater than about 18 hours to form the solid soap composition. In some embodiments, the mixture of step (b) is cured in step (c) for a period of no greater than about 12 hours to form the solid soap composition. In some embodiments, the mixture of step (b) is cured in step (c) for a period of no greater than about 10 hours to form the solid soap composition. In some embodiments, the mixture of step (b) is cured in step (c) for a period of no greater than about 9 hours to form the solid soap composition. In some embodiments, the mixture of step (b) is cured in step (c) for a period of no greater than about 8 hours to form the solid soap composition. In some embodiments, the mixture of step (b) is cured in step (c) for a period of no greater than about 7 hours to form the solid soap composition. In some embodiments, the mixture of step (b) is cured in step (c) for a period of no greater than about 6 hours to form the solid soap composition. In some embodiments, the mixture of step (b) is cured in step (c) for a period of no greater than about 5 hours to form the solid soap composition. In some embodiments, the mixture of step (b) is cured in step (c) for a period of no greater than about 4 hours to form the solid soap composition. In some embodiments, the mixture of step (b) is cured in step (c) for a period of no greater than about 3 hours to form the solid soap composition. In some embodiments, the mixture of step (b) is cured in step (c) for a period of no greater than about 2 hours to form the solid soap composition.

In some embodiments, the mixture of step (b) is cured in step (c) for a period of from about 0.5 hours to about 24 hours to form the solid soap composition. In some embodiments, the mixture of step (b) is cured in step (c) for a period of from about 0.5 hours to about 12 hours to form the solid soap composition. In some embodiments, the mixture of step (b) is cured in step (c) for a period of from about 1 hour to about 6 hours to form the solid soap composition.

Therefore, in one preferred aspect, the process for the production of a solid soap composition comprises the steps of:

(a) contacting a hydroxide solution and a triglyceride to form a saponification mixture;

(b) agitating the saponification mixture at a temperature of from 50 to 70° C. until the mixture has a viscosity of from 300 to 500 cP (for example as measured by a Viscolite 700 Portable viscometer); and

(c) curing the mixture of step (b) at a temperature of from 130 to 170° C. for a period of no greater than about 24 hours to form the solid soap composition.

In some embodiments, the solid soap composition of step (c) is (d) subsequently treated to provide the solid soap composition in particulate form, wherein at least 90% of the weight of the solid soap composition has a size of from 1 to 80 mm. In some embodiments, the process comprises the steps of:

(a) contacting a hydroxide solution and a triglyceride to form a saponification mixture;

(b) agitating the saponification mixture at a temperature of from 50 to 70° C. until the mixture has a viscosity of from 300 to 500 cP (for example as measured by a Viscolite 700 Portable viscometer);

(c) curing the mixture of step (b) at a temperature of from 130 to 170° C. to form the solid soap composition, and

(d) subsequently treating the solid soap composition of step (c) to provide the solid soap composition in particulate form, wherein at least 90% of the weight of the solid soap composition has a size of from 1 to 80 mm.

In some embodiments, the treatment of step (d) is selected from milling, grating and a combination thereof. In some embodiments, the treatment of step (d) is milling. In some embodiments, the treatment of step (d) is grating. In some embodiments, the treatment of step (d) is a combination of milling and grating.

In some embodiments, the solid soap composition produced in step (c) is a solid soap composition in accordance with the present invention. Therefore, in some embodiments, there is provided a process for the production of a solid soap composition, the process comprising the steps of:

(a) contacting a hydroxide solution and a triglyceride to form a saponification mixture;

(b) agitating the saponification mixture at a temperature of from 50 to 70° C. until the mixture has a viscosity of from 300 to 500 cP (for example as measured by a Viscolite 700 Portable viscometer); and

(c) curing the mixture of step (b) at a temperature of from 130 to 170° C. to form the solid soap composition, wherein the solid soap composition comprises soap in an amount of at least 70% by weight of the solid soap composition, and wherein the solid soap composition

(i) has a pH of from 7 to 9.5,

(ii) contains water in an amount of from 0.01 to 15% by weight of the solid soap composition.

It was surprisingly found by the present inventors that a soap composition containing glycerol in an amount from 0.01 to 15% by weight of the composition could be manufactured with excellent resistance to cracking and a reduced rate of mush formation by conserving glycerol in situ during the saponification process and maintaining its presence during the curing phase.

The process of saponifying vegetable butters and vegetable oils is known in the art as the base hydrolysis of triglycerides, producing salts of fatty acids and glycerol.

Vegetable butters and vegetable oils are typically homogenised and mixed with a strong base, such as sodium hydroxide, to initiate the saponification reaction. Saponification may proceed via a ‘cold-process’ or a ‘hot-process’ method for manufacturing soap. The ‘hot-process’ technique requires an external energy input to increase the rate at which the saponification of triglycerides occurs, which differs to the ‘cold-process’ technique which proceeds at ambient temperatures, resulting in a slower rate of saponification in comparison.

It was also found by the present inventors that, by homogenising the triglyceride source at a certain temperature and mixing with a lye solution within a heat-jacketed ribbon blender, a high quality and uniform soap composition could be manufactured.

Ribbon blenders typically comprise a U-shaped horizontal trough and a double helical ribbon agitator, consisting of a set of inner and outer helical blades. The outer ribbon displaces the material from the ends to the centre of the mixture, while the inner ribbon moves the material from the centre to the ends of the mixture. This counter-current action results in the homogeneous and efficient blending of the component parts.

Ribbon blenders are often used in the food and cosmetic industries to homogenise dry ingredients, although they are also known to blend both dry and liquid components.

It was found that ribbon blenders provided excellent blending efficiency of vegetable butters, vegetable oils and lye solution, enabling the saponification of triglycerides to materialise at a faster rate than using traditional single-phase paddle mixers or stick blender.

Therefore, in one preferred aspect, there is provided a process for the production of a solid soap composition, the process comprising the steps of:

(a) contacting a hydroxide solution and a triglyceride to form a saponification mixture in a ribbon blender;

(b) agitating the saponification mixture at a temperature of from 50 to 70° C. until the mixture has a viscosity of from 300 to 500 cP (for example as measured by a Viscolite 700 Portable viscometer); and

(c) curing the mixture of step (b) at a temperature of from 130 to 170° C. to form the solid soap composition.

The composition afforded by the single-phase process according to the present invention may require no further curing and may be considered to be of high quality and homogeneity, thus requiring minimal or no additional processing, such as milling, grating or plodding.

It has been found that solid soap compositions resulting from the aforementioned process of the present invention can subsequently be utilised in the production of more refined and artisan cosmetic soaps, which convey certain qualities that make them beneficial for the use on delicate and sensitive skin.

Furthermore, due to the efficiency, low energy demand and minimal wastage of the aforementioned process, the environmental and social impacts are reduced, whilst minimising the implicit setup and maintenance costs, and also manufacturing times.

Process for the Production of a Solid Soap Product

In one aspect of the present invention, there is provided a process for the production of a solid soap product suitable for cleansing the human body, the process comprising the steps of

(a) providing a solid soap base comprising soap and glycerol;

(b) heating the solid soap base to provide the soap base in liquid form, and optionally contacting the soap base with glycerol, to form a soap liquid mixture;

(c) pouring the soap liquid mixture into a mould and allowing to set to form the solid soap product,

wherein the solid soap product contains glycerol in an amount of from 0.01 to 35% by weight of the solid soap product; and
wherein no greater than 80% by weight of the glycerol present in the solid soap product is added to the soap base.

This manufacturing process of a soap product is typically known in the art as the ‘melt and pour’ technique, whereby a soap base is melted in an aqueous phase, after which additional items such as fragrances, colourants, emollients, humectants and other beneficial additives may be added. Therefore, in some embodiments, the solid soap base is heated in step (b) via the addition of the solid soap base to an aqueous phase that is at a higher temperature than the solid soap base to form a soap liquid mixture. In some embodiments, the solid soap base is heated in step (b) via the addition of the solid soap base to an aqueous phase that is at a higher temperature than the solid soap base to form a soap liquid mixture, wherein the aqueous phase comprises at least one component selected from water, humectant (e.g. honey and/or glycerol), sugar, sugar alcohol, and mixtures thereof. In some embodiments, the solid soap base is heated in step (b) via the addition of the solid soap base to an aqueous phase that is at a higher temperature than the solid soap base to form a soap liquid mixture, wherein the aqueous phase comprises at least one component selected from water, honey, glycerol, agave syrup, sugar, sugar alcohol and mixtures thereof. In some embodiments, the solid soap base is heated in step (b) via the addition of the solid soap base to an aqueous phase that is at a higher temperature than the solid soap base to form a soap liquid mixture, wherein the aqueous phase comprises at least glycerol.

In some embodiments, the solid soap base is heated in step (b) via the addition of the solid soap base to an aqueous phase, wherein the resultant mixture of solid soap base and aqueous phase is heated to form a soap liquid mixture. In some embodiments, the solid soap base is heated in step (b) via the addition of the solid soap base to an aqueous phase, wherein the resultant mixture of solid soap base and aqueous phase is heated to form a soap liquid mixture, and wherein the aqueous phase comprises at least one component selected from water, humectant (e.g. honey and/or glycerol), sugar, sugar alcohol, and mixtures thereof. In some embodiments, the solid soap base is heated in step (b) via the addition of the solid soap base to an aqueous phase, wherein the resultant mixture of solid soap base and aqueous phase is heated to form a soap liquid mixture, and wherein the aqueous phase comprises at least one component selected from water, honey, glycerol, agave syrup, sugar, sugar alcohol, and mixtures thereof. In some embodiments, the solid soap base is heated in step (b) via the addition of the solid soap base to an aqueous phase, wherein the resultant mixture of solid soap base and aqueous phase is heated to form a soap liquid mixture, and wherein the aqueous phase comprises at least glycerol.

In some embodiments, the solid soap base is heated directly in step (b) to provide the soap base in liquid form to form a soap liquid mixture. In some embodiments, the solid soap base is heated directly in step (b) to provide the soap base in liquid form, and the soap base in liquid form is contacted with glycerol to form a soap liquid mixture.

In some embodiments, the solid soap base is heated in step (b) to provide the soap base in liquid form, and then subsequently contacted with an aqueous phase to form a soap liquid mixture. In some embodiments, the solid soap base is heated in step (b) to provide the soap base in liquid form, and then subsequently contacted with an aqueous phase to form a soap liquid mixture, wherein the aqueous phase comprises at least one component selected from water, humectant (e.g. honey and/or glycerol), sugar, sugar alcohol, and mixtures thereof. In some embodiments, the solid soap base is heated in step (b) to provide the soap base in liquid form, and then subsequently contacted with an aqueous phase to form a soap liquid mixture, wherein the aqueous phase comprises at least one component selected from water, honey, glycerol, agave syrup, sugar, sugar alcohol, and mixtures thereof. In some embodiments, the solid soap base is heated in step (b) to provide the soap base in liquid form, and then subsequently contacted with an aqueous phase to form a soap liquid mixture, wherein the aqueous phase comprises at least glycerol.

In one preferred aspect, the aqueous phase comprises water. In embodiments where the aqueous phase comprises water, the water may be present in an amount of from 0.5 to 48.5% by weight of the solid soap product, such as in an amount of from 1 to 45% by weight of the solid soap product, such as in an amount of from 10 to 40% by weight of the solid soap product, such as in an amount of from 15 to 35% by weight of the solid soap product, such as in an amount of from 15 to 32.5% by weight of the solid soap product. The water present in the aqueous phase may be provided from any suitable source. In one aspect the water in the aqueous phase is provided from a source selected from distilled water, deionised water, tap water, plant infusions, plant decoctions (including tea and coffee), fruit juices, vegetable juices, vinegar, beers, wines, spirits and mixtures thereof. In one aspect the water in the aqueous phase is provided from a source selected from distilled water, deionised water and tap water.

In one preferred aspect, the aqueous phase comprises honey. In embodiments where the aqueous phase comprises honey, the honey may be present in an amount of from 0.1 to 30% by weight of the solid soap product.

In one preferred aspect, the aqueous phase comprises sugar. In one aspect, the sugar is selected from sucrose, fructose, and mixtures thereof. In one aspect, the sugar is sucrose. In one aspect, the sugar is fructose. In one aspect, the sugar is selected from caster sugar, granulated sugar, brown sugar, sucrose powder, fructose powder, and mixtures thereof. In embodiments where the aqueous phase comprises sugar, the sugar may be present in an amount of from 0.1 to 30% by weight of the solid soap product. In embodiments where the aqueous phase comprises sugar selected from caster sugar, granulated sugar, brown sugar, sucrose powder, fructose powder, and mixtures thereof, the sugar may be present in an amount of from 0.1 to 10% by weight of the solid soap product.

In one preferred aspect, the aqueous phase comprises a sugar alcohol. In one aspect, the sugar alcohol is selected from sorbitol, maltitol, mannitol, and mixtures thereof. In embodiments where the aqueous phase comprises a sugar alcohol, the sugar alcohol may be present in an amount of from 0.1 to 10% by weight of the solid soap product.

As the skilled person will appreciate, the use of honey and/or sugars and/or sugar alcohols (in the presence of heat and an additional humectant such as glycerol, where the glycerol may be present within the soap base itself) results in the formation of a syrup. During production of melt and pour soaps, heat may be transferred through this syrup to the humectant such as glycerol present in the soap base. This energy transfer allows the saponified fatty acids to be released out of their micelle structure. The saponified heads are attracted to the water content of the syrup, whilst the fatty chain can reside within the sugar content of syrup. This allows the soap to melt and create a composition that can be easily manipulated by the inclusion of additional materials as listed previously. This may allow for a soap product to be produced without the need for including propylene glycol, as described in detail in WO 2015/128649. However, in some aspects, a soap product may be produced including propylene glycol, wherein the propylene glycol is added during step (b) of the aforementioned process.

Whilst still in a molten state, the composition can be poured into moulds and cooled, yielding a refined solid soap product suitable for cleansing the human body, wherein the product can be sliced, pressed or removed as a solid bar.

In some embodiments, the solid soap base is a solid soap composition in accordance with the present invention. Therefore, in some embodiments, there is provided a process for the production of a solid soap product suitable for cleansing the human body, the process comprising the steps of

(a) providing a solid soap composition comprising glycerol and soap in an amount of at least 70% by weight of the solid soap composition, wherein the solid soap composition (i) has a pH of from 7 to 9.5, and (ii) contains water in an amount of from 0.01 to 15% by weight of the solid soap composition;

(b) heating the solid soap composition to provide the soap composition in liquid form, and optionally contacting the soap composition with glycerol, to form a soap liquid mixture;

(c) pouring the soap liquid mixture into a mould and allowing to set to form the solid soap product,

wherein the solid soap product contains glycerol in an amount of from 0.01 to 35% by weight of the solid soap product; and
wherein no greater than 80% by weight of the glycerol present in the solid soap product is added to the soap base.

In some embodiments, the solid soap base is a solid soap composition that is produced by a process in accordance with the present invention. Therefore, in some embodiments, there is provided a process for the production of a solid soap product suitable for cleansing the human body, the process comprising the steps of

(a) providing a solid soap composition comprising glycerol and soap in an amount of at least 70% by weight of the solid soap composition, wherein the solid soap composition (i) has a pH of from 7 to 9.5, and (ii) contains water in an amount of from 0.01 to 15% by weight of the solid soap composition by:
(a-i) contacting a hydroxide solution and a triglyceride to form a saponification mixture;
(a-ii) agitating the saponification mixture at a temperature of from 50 to 70° C. until the mixture has a viscosity of from 300 to 500 cP (for example as measured by a Viscolite 700 Portable viscometer);
(a-iii) curing the mixture of step (a-ii) at a temperature of from 130 to 170° C. to form the solid soap composition comprising glycerol and soap;

(b) heating the solid soap composition to provide the soap composition in liquid form, and optionally contacting the soap composition with glycerol, to form a soap liquid mixture;

(c) pouring the soap liquid mixture into a mould and allowing to set to form the solid soap product,

wherein the solid soap product contains glycerol in an amount of from 0.01 to 35% by weight of the solid soap product; and
wherein no greater than 80% by weight of the glycerol present in the solid soap product is added to the soap base.

In some embodiments, the solid soap product comprises glycerol in an amount of from 0.01 to 35% by weight of the solid soap product, such as from 0.5 to 30% by weight of the solid soap product, such as from 1 to 30% by weight of the solid soap product, such as from 2.5 to 27.5% by weight of the solid soap product, such as from 5 to 25% by weight of the solid soap product.

In some embodiments, glycerol is added to the soap base in step (b) in an amount of no greater than 20% by weight of the solid soap product, such as in an amount of no greater than 17.5% by weight of the solid soap product, such as in an amount of no greater than 15% by weight of the solid soap product, such as in an amount of no greater than 14% by weight of the solid soap product, such as in an amount of no greater than 13% by weight of the solid soap product, such as in an amount of no greater than 12.5% by weight of the solid soap product in order that no greater than 80% by weight of the glycerol present in the solid soap product is added to the soap base.

In some embodiments, the process for producing a solid soap product suitable for cleansing the human body further comprises an additional step (b-i) before step (c), wherein step (b-i) comprises adding one or more additional components to the soap liquid mixture. In one aspect the one or more additional components are selected from honey, sugars, sugar alcohols, surfactants, oils, butters, waxes, fruits, vegetables, clays, herbs, cereals, beans, proteins, binders, fillers, opacifiers, perfumes, colours, fragrances, scrubs, exfoliants and mixtures thereof.

In embodiments where sugars are added in step (b-i), the sugars may be added in an amount of from 0.1 to 30% by weight of the solid soap product, such as in an amount of from 0.1 to 10% by weight of the solid soap product.

In embodiments where sugar alcohols are added in step (b-i), the sugar alcohols may be added in an amount of from 0.1 to 10% by weight of the solid soap product.

In embodiments where honey is added in step (b-i), the honey may be added in an amount of from 0.1 to 30% by weight of the solid soap product.

It was surprisingly found that the particle size and density of the solid soap particulates in the soap base may have an effect on the dissolution of the soap composition during the ‘melt and pour’ manufacturing process. It was found that, if the particulates are too great in size or the density is too great, a mass agglomerate may be formed, which may subsequently deteriorate due to excessive heat transfer and ineffectual dissolution within the aqueous phase. If the particle size is too small, or the density is too low, the soap particulates may remain on the surface of the aqueous phase and form a layer, which may subsequently deteriorate due to excessive heat transfer and ineffectual dissolution within the aqueous phase. The optimal particle size was found to be where at least 90% by weight of the solid soap composition has a particle size of from 1 to 80 mm. The optimal density was found to be of from 0.5 g/cm³ to 1.5 g/cm³.

Therefore, in some embodiments, there is provided a process for the production of a solid soap product suitable for cleansing the human body, the process comprising the steps of

(a) providing a solid soap base comprising soap and glycerol, wherein the soap base is in particulate form, wherein at least 90% by weight of the solid soap composition has a size of from 1 to 80 mm;

(b) heating the solid soap base to provide the soap base in liquid form, and optionally contacting the soap base with glycerol, to form a soap liquid mixture;

(c) pouring the soap liquid mixture into a mould and allowing to set to form the solid soap product,

wherein the solid soap product contains glycerol in an amount of from 0.01 to 35% by weight of the solid soap product; and
wherein no greater than 80% by weight of the glycerol present in the solid soap product is added to the soap base.

In some embodiments, there is provided a process for the production of a solid soap product suitable for cleansing the human body, the process comprising the steps of (a) providing a solid soap base comprising soap and glycerol, wherein the soap base has a density of from 0.5 g/cm³ to 1.5 g/cm³;

(b) heating the solid soap base to provide the soap base in liquid form, and optionally contacting the soap base with glycerol, to form a soap liquid mixture;

(c) pouring the soap liquid mixture into a mould and allowing to set to form the solid soap product,

wherein the solid soap product contains glycerol in an amount of from 0.01 to 35% by weight of the solid soap product; and
wherein no greater than 80% by weight of the glycerol present in the solid soap product is added to the soap base.

Solid Soap Product

In some embodiments, there is provided a solid soap product suitable for cleansing the human body obtained or obtainable from a process, the process comprising the steps of

(a) providing a solid soap base comprising soap and glycerol;

(b) heating the solid soap base to provide the soap base in liquid form, and optionally contacting the soap base with glycerol, to form a soap liquid mixture;

(c) pouring the soap liquid mixture into a mould and allowing to set to form the solid soap product,

wherein the solid soap product contains glycerol in an amount of from 0.01 to 35% by weight of the solid soap product; and
wherein no greater than 80% by weight of the glycerol present in the solid soap product is added to the soap base.

In some embodiments, the solid soap base is a solid soap composition in accordance with the present invention. Therefore, in some embodiments, there is provided a solid soap product suitable for cleansing the human body obtained or obtainable from a process, the process comprising the steps of

(a) providing a solid soap composition comprising glycerol and soap in an amount of at least 70% by weight of the solid soap composition, wherein the solid soap composition (i) has a pH of from 7 to 9.5, and (ii) contains water in an amount of from 0.01 to 15% by weight of the solid soap composition;

(b) heating the solid soap base to provide the soap base in liquid form, and optionally contacting the soap base with glycerol, to form a soap liquid mixture;

(c) pouring the soap liquid mixture into a mould and allowing to set to form the solid soap product,

wherein the solid soap product contains glycerol in an amount of from 0.01 to 35% by weight of the solid soap product; and
wherein no greater than 80% by weight of the glycerol present in the solid soap product is added to the soap base.

As described herein the solid soap product is suitable for cleansing the human body. Therefore, the solid soap product is suitable for use in a method comprising contacting the skin of a user with the solid soap product. The solid soap product may be self-applied by the user or applied by another individual. The solid soap product is preferably used by the user as a cleanser for the skin.

In some embodiments, the solid soap product comprises glycerol, wherein the total amount of glycerol present in the solid soap product is from 0.01 to 35% by weight of the solid soap product, such as from 0.5 to 30% by weight of the solid soap product, such as from 1 to 30% by weight of the solid soap product, such as from 1 to 27.5% by weight of the solid soap product, such as from 1 to 25% by weight of the solid soap product, such as from 1 to 22.5% by weight of the solid soap product, such as from 1 to 20% by weight of the solid soap product, such as in an amount of from 2 to 20% by weight of the solid soap product, such as in an amount of from 2.5 to 17.5% by weight of the solid soap product. As used herein, the term “total amount of glycerol” means the total combined amount of glycerol present in the soap base and the amount of additional glycerol in the solid soap product.

As used herein, the term “additional glycerol” means glycerol that is added to the soap base in step (b)—heating the solid soap base to provide the soap base in liquid form, and optionally contacting the soap base with glycerol, to form a soap liquid mixture—of the process for producing a solid soap product suitable for cleansing the human body. Therefore, “additional glycerol” means any glycerol in the solid soap product which was not present in the soap base prior to forming the soap liquid mixture in step (b). In some embodiments, the solid soap product comprises additional glycerol in an amount of no greater than 20% by weight of the solid soap product, such as in an amount of no greater than 17.5% by weight of the solid soap product, such as in an amount of no greater than 15% by weight of the solid soap product, such as in an amount of no greater than 14% by weight of the solid soap product, such as in an amount of no greater than 13% by weight of the solid soap product, such as in an amount of no greater than 12.5% by weight of the solid soap product in order that no greater than 80% by weight of the glycerol present in the solid soap product is added to the soap base.

In some embodiments, the solid soap product suitable for cleansing the human body comprises a soap base in an amount of at least 25% by weight of the solid soap product, such as in an amount of at least 30% by weight of the solid soap product, such as in an amount of at least 35% by weight of the solid soap product, such as in an amount of at least 37.5% by weight of the solid soap product.

In one preferred aspect, the solid soap product suitable for cleansing the human body comprises a soap base in an amount of from 20% to 70% by weight of the solid soap product, such as in an amount of from 25% to 65% by weight of the solid soap product, such as in an amount of from 30% to 60% by weight of the solid soap product, such as in an amount of from 35% to 60% by weight of the solid soap product, such as in an amount of from 35% to 57.5% by weight of the solid soap product, such as in an amount of from 35% to 55% by weight of the solid soap product.

In some embodiments, the solid soap product suitable for cleansing the human body comprises soap in an amount of at least 50% by weight of the solid soap product, such as in an amount of from 50 to 90% by weight of the solid soap product.

In some embodiments, the solid soap product suitable for cleansing the human comprises water, wherein the total amount of water present in the solid soap product is from 0.01 to 49% by weight of the solid soap product, such as from 0.1 to 49% by weight of the solid soap product, such as from 1 to 49% by weight of the solid soap product, such as from 5 to 49% by weight of the solid soap product, such as from 5 to 45% by weight of the solid soap product, such as from 10 to 45% by weight of the solid soap product, such as from 10 to 40% by weight of the solid soap product, such as from 15 to 40% by weight of the solid soap product, such as from 15 to 35% by weight of the solid soap product, such as from 17.5 to 35% by weight of the solid soap product. As used herein, the term “total amount of water” means the total combined amount of water present in the soap base and the amount of additional water in the solid soap product. It was found that when the solid soap product comprises a total amount of water of from 1 to 49% by weight of the solid soap product, homogeneous particulates of the solid soap composition may be yielded.

As used herein, the term “additional water” means water that is added to the soap base during the process for producing a solid soap product suitable for cleansing the human body. Therefore, “additional water” means any water in the solid soap product which was not present in the soap base prior to forming the soap liquid mixture. For example, “additional water” may mean any water present in the aqueous phase in embodiments wherein the solid soap base is heated in step (b) via the addition of the solid soap base to an aqueous phase that is at a higher temperature than the solid soap base to form a soap liquid mixture. In some embodiments, the solid soap product suitable for cleansing the human body comprises no additional water. In some embodiments, the solid soap product suitable for cleansing the human body comprises additional water in an amount of from 0.5 to 48.5% by weight of the solid soap product, such as in an amount of from 1 to 45% by weight of the solid soap product, such as in an amount of from 10 to 40% by weight of the solid soap product, such as in an amount of from 15 to 35% by weight of the solid soap product, such as in an amount of from 15 to 32.5% by weight of the solid soap product.

The water present in the solid soap product may be provided from any suitable source. In one aspect the water is provided from a combination of the moisture content of the solid soap base and a source selected from distilled water, deionised water, tap water, plant infusions, plant decoctions (including tea and coffee), fruit juices, vegetable juices, vinegar, beers, wines, spirits and mixtures thereof. In one aspect the water is provided from a combination of the moisture content of the solid soap base and a source selected from distilled water, deionised water and tap water.

The solid soap product suitable for cleansing the human body may contain one or more additional components such as to provide the desired composition. In one aspect the solid soap product further comprises at least one additional component selected from honey, sugars, sugar alcohols surfactants, oils, butters, waxes, fruits, vegetables, clays, herbs, cereals, beans, proteins, binders, fillers, opacifiers, perfumes, colours, fragrances, scrubs, exfoliants and mixtures thereof.

In one aspect, the solid soap product further comprises honey. In one preferred aspect, the solid soap product comprises honey and essentially no additional glycerol that has been added to the soap base. In one aspect, the solid soap product comprises honey in an amount of from 0.1 to 30% by weight of the solid soap product, such as in an amount of from 1 to 25% by weight of the solid soap product, such as in an amount of from 5 to 25% by weight of the solid soap product, such as in an amount of from 10 to 25% by weight of the solid soap product, such as in an amount of from 15 to 25% by weight of the solid soap product. In one aspect, the solid soap product comprises essentially no glycerol added to the soap base, and honey in an amount of from 15 to 25% by weight of the solid soap product.

In one aspect, the solid soap product further comprises sugar. In one aspect, the sugar is selected from sucrose, fructose, and mixtures thereof. In one aspect, the sugar is sucrose. In one aspect, the sugar is fructose. In one aspect, the sugar is selected from caster sugar, granulated sugar, brown sugar, sucrose powder, fructose powder, and mixtures thereof. In one aspect, the solid soap product further comprises sugar (preferably, caster sugar, granulated sugar, brown sugar, sucrose powder, fructose powder, or mixtures thereof) in an amount of from 0.1 to 30% by weight of the solid soap product, such as from 1 to 25% by weight of the solid soap product, such as from 5 to 25% by weight of the solid soap product. In some embodiments, the solid soap product further comprises caster sugar, granulated sugar, brown sugar, sucrose powder, fructose powder, or mixtures thereof in an amount of from 0.1 to 10% by weight of the solid soap product, such as from 0.5 to 10% by weight of the solid soap product, such as from 1 to 10% by weight of the solid soap product, such as from 5 to 10% by weight of the solid soap product, such as from 6 to 10% by weight of the solid soap product, such as from 7 to 10% by weight of the solid soap product, such as from 8 to 10% by weight of the solid soap product.

In one aspect, the solid soap product further comprises a sugar alcohol. In one aspect, the sugar alcohol is selected from sorbitol, maltitol, mannitol, and mixtures thereof. If present, the sugar alcohol may be present in an amount of from 0.1 to 10% by weight of the solid soap product.

In one aspect the solid soap product further comprises an additional surfactant. Additional surfactants may be selected from sodium lauryl sulfate, sodium laureth sulfate, ammonium lauryl sulfate, ammonium laureth sulfate, sodium cocoamphoacetate, disodium laureth sulfosuccinate, lauryl betaine, and mixtures thereof. If present, the additional surfactant may be present in an amount of from 0.1 to 35% by weight of the solid soap product.

In one aspect the solid soap product further comprises oil, butter, waxes or mixtures thereof. The oil, butter, waxes or mixtures thereof (if present) may be incorporated in a process known as “Superfatting”. Oil, butter and waxes may be selected from almond oil, olive oil, sesame oil, evening primrose oil, jojoba oil, cocoa butter, shea butter, mango butter, cupuacu butter, lanolin, beeswax, rose wax and orange peel wax. If present, the oil, butter and waxes may be present in a combined amount of from 0.1 to 10% by weight of the solid soap product, such as from 0.1 to 5% by weight of the solid soap product, such as from 1 to 5% by weight of the solid soap product.

In one aspect the solid soap product further comprises fruits and vegetables. Fruits and vegetables may be selected from olives, avocado, banana, strawberries and blueberries, if present, the fruits and vegetables may be present in a combined amount of from 0.1% to 10% by weight of the solid soap product, such as from 0.1 to 5% by weight of the solid soap product, such as from 1 to 5% by weight of the solid soap product.

In one aspect the solid soap product further comprises a fragrance. If present, fragrance may be present in an amount of from 0.1% to 10% by weight of the solid soap product. Fragrance may be added to the product to make the experience of using the present composition more pleasant. Combining essential oils such as lavender, chamomile or rose absolute into fragrances for the invention ensures the user has a pleasant washing experience. The amount of fragrances is preferably from 0.1% to 5% by weight of the solid soap product, such as from 0.5% to 5% by weight of the solid soap product, such as from 1% to 5% by weight of the solid soap product, such as from 1% to 4% by weight of the solid soap product, such as from 2% to 4% by weight of the solid soap product.

The essential oils may be selected based on the fragrance desired, skin type to be treated and other effects desired based on the well-known properties of essential oils. The addition of essential oils, when taken in to the nose, is known to alter mood. For example, essential oils are known to create effects of drowsiness or stimulating the senses. Many well documented effects can be achieved by the use of essential oils.

In one embodiment, the one or more essential oils present in the product are selected from Tarragon, Lemon myrtle, Jasmin, Ylang ylang, Labdanum, Lemongrass, Rose otto, Grapefruit, Patchouli, Rosemary, Armois, Lemon, Neroli, Sweet violet, Lavender, Orange 50 fold, Vanilla, Peppermint, Benzoin, Hydrangea, Litsea Cubeba, Cardamon, Tonka, and Chamomile blue. In one embodiment, the one or more essential oils present in the product are selected from Tarragon, Lemon myrtle, Labdanum, and Lemongrass.

Vitamins, particularly B, C and E are very beneficial for the skin. Vitamin rich ingredients such as Wheatgerm oil can also be used to deliver vitamins on to the skin. In one embodiment, the vitamins are selected from vitamin B, vitamin C, vitamin E and mixtures thereof. It will be appreciated by one skilled in the art that the vitamin may be provided from any suitable source. For example the vitamin(s) may be provided from a synthetic source or from incorporation into the product of a material, such as a natural material, that has a high vitamin content.

In one aspect the solid soap product further comprises a colorant material. If present, colorant materials may be present in an amount of from 0.001 to 3% by weight of the solid soap product.

In one aspect the solid soap product further comprises a clay. The clay may be selected from all suitable clays. Preferably the clay is selected from kaolin, talc, calamine, rhassoul mud, fullers earth, bentonite clays and mixtures thereof. If present, the clay may be present in an amount of from 0.1 to 10% by weight of the solid soap product, such as in an amount of from 1 to 10% by weight of the solid soap product.

In one aspect the solid soap product further comprises herbs, cereals, beans or mixtures thereof. Preferably the herbs, cereals, beans or mixtures thereof are selected from oats, rice, cinnamon, vanilla, aduki beans, seaweeds and mixtures thereof. If present, the herbs, cereals, beans or mixtures may be present a combined amount of from 0.01 to 10% by weight of the solid soap product, such as in a combined amount of from 0.1 to 10% by weight of the solid soap product.

In one aspect the solid soap product further comprises a protein. The protein may be selected from all suitable proteins. Preferably the protein is selected tofu, banana, soya, soya lecithin, eggs and mixtures thereof. If present, the protein may be present in an amount of from 0.1% to 10% by weight of the solid soap product.

Further Aspects

In further aspects the present invention provides:

A solid soap base for preparing a solid soap product, the solid soap base comprising soap in an amount of at least 70% by weight of the solid soap base, wherein the solid soap base

(i) has a pH of from 7 to 9.5,

(ii) contains water in an amount of from 0.01 to 15% by weight of the solid soap base.

A process for the production of a solid soap base comprising the steps of

(a) contacting a hydroxide solution and a triglyceride to form a saponification mixture;

(b) agitating the saponification mixture at a temperature of from 50 to 70° C. until the mixture has a viscosity of from 300 to 500 cP (for example as measured by a Viscolite 700 Portable viscometer); and

(c) curing the mixture of step (b) at a temperature of from 130 to 170° C. to form the solid soap composition.

A process for the production of a solid soap product suitable for cleansing the human body, the process comprising the steps of

(a) providing a solid soap base comprising soap and glycerol;

(b) heating the solid soap base to provide the soap base in liquid form, and optionally contacting the soap base with glycerol, to form a soap liquid mixture;

(c) pouring the soap liquid mixture into a mould and allowing to set to form the solid soap composition,

wherein the solid soap product contains glycerol in an amount of from 0.01 to 35% by weight of the solid soap product; and
wherein no greater than 80% by weight of the glycerol present in the solid soap product is added to the soap base.

A solid soap product obtained or obtainable from a soap base, the solid soap product comprising

(i) soap in an amount of at least 50% by weight of the solid soap product,

(ii) water in an amount of from 1 to 49.9% by weight of the solid soap product, and

(iii) glycerol in an amount of from 0.01 to 35% by weight of the solid soap product,

wherein no greater than 80% by weight of the glycerol present in the solid soap product is added to the soap base.

A solid soap product comprising

(i) soap in an amount of at least 50% by weight of the solid soap product,

(ii) water in an amount of from 1 to 49.9% by weight of the solid soap product, and

(iii) glycerol in an amount of from 0.01 to 35% by weight of the solid soap product.

### EXAMPLES

The invention will now be described with reference to the following non-limiting examples. In the Examples solid soap products suitable for cleansing the human body were prepared.

### Example 1

A number of solid soap compositions were prepared from the following vegetable butters and vegetable oils.

| Example | Vegetable Butter/Oil |
|---|---|
| 1a | Cocoa Butter |
| 1b | Avocado Oil |
| 1c | Argan Oil |
| 1d | Sunflower Oil |
| 1e | Kalahari Melon Oil |
| 1f | Baobab Oil |
| 1g | Castor Oil |
| 1h | Shea Butter |
| 1i | Almond Oil |
| 1j | Coconut oil, Castor oil and Cocoa butter |
| 1k | Olive Oil |

The solid soap compositions were prepared using the following method:

1. Vegetable oils were heated to 60° C. in a jacketed ribbon blender, until component parts were in a liquid phase and homogeneous.

2. Sodium hydroxide was added to sodium citrate solution. The resulting solution of sodium hydroxide and sodium citrate was then added to the molten vegetable oils to initiate saponification.

3. All component parts were mixed together at 60° C. until the viscosity of the composition was from 300 to 500 cP as measured by a Viscolite 700 Portable viscometer.

4. The temperature was then increased to 150° C., and the composition mixed at a rate of from 45-55 rpm to cure the soap composition until the soap composition had a pH of from 7 to 9.5 and a water content of from 0.01 to 15% by weight of the soap composition.

### Example 1a

Using the above method, a solid soap composition was prepared from cocoa butter by addition of sodium hydroxide and sodium citrate to the vegetable butter in the amounts shown in the table below:

Batch Size (g) 100.00

| | Weight % | Raw Material Type | (g) |
|---|---|---|---|
| A | 26.96 | 10% Sodium Citrate Solution | 26.960 |
| B | 9.86 | Sodium Hydroxide | 9.860 |
| C | 63.18 | Cocoa Butter | 63.180 |
| | 100.000 | | 100.000 |

The soap compositions of Examples 1a to 1k were analysed for water content, pH and glycerol content. The following results were obtained:

Water Content

| Example | Water Content (wt. %) |
|---|---|
| 1a | 6.70 |
| 1b | 4.80 |
| 1c | 1.70 |
| 1d | 4.73 |
| 1e | 0.79 |
| 1f | 2.72 |
| 1g | 4.33 |
| 1h | 4.00 |
| 1i | 2.14 |
| 1j | 2.58 |
| 1k | 0.70 |

pH

| Example | pH |
|---|---|
| 1a | 7.1 |
| 1b | 8.5 |
| 1c | 9.3 |
| 1d | 9.2 |
| 1e | 8.3 |
| 1f | 9.0 |
| 1g | 8.2 |
| 1h | 8.9 |
| 1i | 8.4 |
| 1j | 8.7 |
| 1k | 7.9 |

Glycerol Content

| Example | Glycerol Content (wt. %) |
|---|---|
| 1a | 7.4 |
| 1b | 5.8 |
| 1c | 8.5 |
| 1d | 8.2 |
| 1e | 8.5 |
| 1f | 8.6 |
| 1g | 7.1 |
| 1h | 6.3 |
| 1i | 8.5 |
| 1j | 8.6 |
| 1k | 7.7 |

### Example 1l

Using the method disclosed above for Example 1, a solid soap composition was prepared from a mixture of sunflower oil and olive oil by addition of sodium hydroxide and sodium citrate to the vegetable oils in the amounts shown in the table below:

Batch Size (g) 100.00

| | Weight % | Raw Material Type | (g) |
|---|---|---|---|
| A | 23.75 | 10% Sodium Citrate Solution | 23.750 |
| B | 6.34 | Sodium Hydroxide | 6.340 |
| C | 32.50 | Sunflower Oil | 32.500 |
| | 37.41 | Olive Oil | 37.410 |
| | 100.000 | | 100.000 |

### Example 1m

A solid soap composition was prepared from cocoa butter by addition of sodium hydroxide solution in the amounts shown in the table below:

Batch Size (g) 100.00

| | Weight % | Raw Material Type | (g) |
|---|---|---|---|
| A | 78.09 | Cocoa Butter | 78.090 |
| B | 21.91 | 47% Sodium Hydroxide Solution | 21.910 |
| | 100.000 | | 100.000 |

The solid composition was prepared using the following method:

1. Vegetable oils were heated to 60° C. in a jacketed ribbon blender, until component parts were in a liquid phase and homogeneous.

2. Sodium hydroxide solution was added to the molten vegetable oils to initiate saponification.

3. All component parts were mixed together at 60° C. until the viscosity of the composition was from 300 to 500 cP as measured by a Viscolite 700 Portable viscometer.

4. The temperature was then increased to 150° C., and the composition mixed at a rate of from 45-55 rpm to cure the soap composition until the soap composition had a pH of from 7 to 9.5 and a water content of from 0.01 to 15% by weight of the soap composition.

### Example 1n

Using the method disclosed above for Example 1m, a solid soap composition was prepared from a mixture of almond oil, olive oil and castor oil by addition of sodium hydroxide to the vegetable oils in the amounts shown in the table below:

Batch Size (g) 100.00

| | Weight % | Raw Material Type | (g) |
|---|---|---|---|
| A | 24.56 | Almond Oil | 24.560 |
| | 24.56 | Olive Oil | 24.560 |
| | 24.56 | Castor Oil | 24.560 |
| B | 26.32 | 47% Sodium Hydroxide Solution | 26.320 |
| | 100.000 | | 100.000 |

### Example 2

The following solid soap product suitable for cleansing the human body was prepared. The soap product had the following composition:

Batch Size (g) 100.00

| | Weight % | Raw Material Type | (g) |
|---|---|---|---|
| A | 17.15 | Water | 17.150 |
| | 9.75 | Granulated Sugar | 9.750 |
| | 11.50 | Glycerol | 11.500 |
| B | 55.00 | Olive Oil Soap Base | 55.000 |
| C | 2.60 | Olive Oil | 2.600 |
| D | 4.00 | Fragrance | 4.000 |
| | 100.000 | | 100.000 |

Method
1. Phase A was warmed to approximately 85° C.
2. The vegetable oil soap base of phase B was gradually added to phase A whilst maintaining the temperature.
3. Phases A and B were whisked together until all the soap base had melted.
4. The mixture was cooled to approximately 35° C.
5. Phases C and D were then added.
6. The resulting soap liquid mixture was then poured into moulds, and cooled to set.

### Example 3

The following solid soap product suitable for cleansing the human body was prepared. The soap product had the following composition

Batch Size (g) 100.00

| | Weight % | Raw Material Type | (g) |
|---|---|---|---|
| A | 24.25 | Water | 24.250 |
| | 18.75 | Honey | 18.750 |
| B | 29.50 | Almond Oil Soap Base | 29.500 |
| | 20.50 | Cocoa Butter Soap Base | 20.500 |
| C | 2.00 | Almond Milk | 2.000 |
| | 2.00 | Almond Oil | 2.000 |
| D | 3.00 | Fragrance | 3.000 |
| | 100.000 | | 100.000 |

Method
1. Phase A was warmed to approximately 85° C.
2. The vegetable oil soap base and vegetable butter soap base of phase B were gradually added to phase A whilst maintaining the temperature.
3. Phases A and B were whisked together until all the soap base had melted.
4. The mixture was cooled to approximately 35° C.
5. Phases C and D were then added.
6. The resulting soap liquid mixture was then poured into moulds, and cooled to set.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology or related fields are intended to be within the scope of the following claims.

1. A solid soap composition comprising soap in an amount of at least 70% by weight of the solid soap composition, wherein the solid soap composition:
(i) has a pH of from 7 to 9.5,
(ii) contains water in an amount of from 0.01% to 15% by weight of the solid soap composition.

2. A solid soap composition according to claim 1, wherein the solid soap composition has a pH of from 7.1 to 9.3.

3. A solid soap composition according to claim 1, wherein the soap composition contains water in an amount of from 0.1% to 10% by weight of the solid soap composition.

4. A solid soap composition according to claim 1, wherein the soap composition contains water in an amount of from 0.2% to 7% by weight of the solid soap composition.

5. A solid soap composition according to claim 1, wherein the solid soap composition contains soap in an amount of at least 80% by weight of the solid soap composition.

6. A solid soap composition according to claim 1, wherein the solid soap composition contains soap in an amount of approximately 85% by weight of the solid soap composition.

7. A solid soap composition according to claim 1, wherein the solid soap composition consists of or consists essentially of soap.

8. A solid soap composition according to claim 1, wherein the solid soap composition is in particulate form, wherein at least 90% of the weight of the solid soap composition has a particle size of from 1 mm to 80 mm.

9. A solid soap composition according to claim 1, wherein the solid soap composition further comprises glycerol.

10. A solid soap composition according to claim 1, wherein the solid soap composition further comprises glycerol in an amount of from 0.01% to 15% by weight of the solid soap composition.

11. A solid soap composition according to claim 1, wherein the solid soap composition further comprises glycerol in an amount of from 5% to 15% by weight of the solid soap composition.

12. A solid soap composition according to claim 1, wherein the soap is saponified vegetable oil or butter.

13. A solid soap composition according to claim 1, wherein the solid soap composition is a soap base for preparing a solid soap product adapted for cleansing the human body.

14. A process for the production of a solid soap composition, the process comprising the steps of:
(a) contacting a hydroxide solution and a triglyceride to form a saponification mixture;
(b) agitating the saponification mixture at a temperature of from 50° C. to 70° C. until the mixture has a viscosity of from 300 cP to 500 cP:
(c) curing the mixture of step (b) at a temperature of from 130° C. to 170° C. to form the solid soap composition.

15. A process according to claim 14, wherein the solid soap composition of step (c) is
(d) subsequently treated to provide the solid soap composition in particulate form, wherein at least 90% of the weight of the solid soap composition has a particle size of from 1 to 80 mm.

16. A process according to claim 15, wherein the treatment of step (d) is milling, grating or a combination of milling and grating.

17. A process according to claim 14, wherein the solid soap composition is a solid soap composition comprising soap in an amount of at least 70% by weight of the solid soap composition, wherein the solid soap composition:
(i) has a pH of from 7 to 9.5,
(ii) contains water in an amount of from 0.01% to 15% by weight of the solid soap composition.

18. A process for the production of a solid soap product for cleansing the human body, the process comprising the steps of
(a) providing a solid soap base comprising soap and glycerol;
(b) heating the solid soap base to provide the soap base in liquid form, and contacting the soap base with glycerol, to form a soap liquid mixture;
(c) pouring the soap liquid mixture into a mould and allowing the soap liquid mixture to set to form the solid soap product,
wherein the solid soap product contains glycerol in an amount of from 0.01% to 35% by weight of the solid soap product; and
wherein no greater than 80% by weight of the glycerol present in the solid soap product is added to the soap base.

19. A process according to claim 18, wherein the solid soap base is a solid soap composition comprising soap in an amount of at least 70% by weight of the solid soap composition, wherein the solid soap composition:
(i) has a pH of from 7 to 9.5,
(ii) contains water in an amount of from 0.01% to 15% by weight of the solid soap composition.

20-23. (canceled)
